(19) United States
(12) Patent Application Publication
(10) Pub. No.: US 2009/0235026 A1
(43) Pub. Date: Sep. 17, 2009

(54) DATA TRANSFER CONTROL DEVICE AND DATA TRANSFER CONTROL METHOD

(75) Inventor: Atsushi KAWATA, Kanagawa (JP)

Correspondence Address: COOPER & DUNHAM, LLP, 30 Rockefeller Plaza, 20th Floor, NEW YORK, NY, 10112, US

(73) Assignee: RICOH COMPANY, LTD., TOKYO (JP)

(21) Appl. No.: 12/399,188

(22) Filed: Mar. 6, 2009

(30) Foreign Application Priority Data
Mar. 11, 2008 (JP) JP2008-061758

(51) Int. Cl. G06F 12/08; G06F 12/06

(52) U.S. Cl. 711/118; 711/157; 711/E12.017; 711/E12.079

(57) ABSTRACT

A disclosed data transfer control device includes a main memory unit; a cache memory unit; a command generation unit configured to generate a command to read out data from the main memory unit in accordance with a first address input to the command generation unit; and a storage unit configured to store an information item indicating whether the first address and data corresponding to the first address are stored in the cache memory unit. In the data transfer control device, when the information item stored in the storage unit indicates that there are no data corresponding to the first address in the cache memory unit, the command generation unit generates the command based on the first address before output of data corresponding to a second address that is input immediately before the first address is input.

### BACKGROUND OF THE INVENTION

1. Field of the Invention

The present invention generally relates to a data transfer control device configured to control a data transfer from main memory means (a main memory).

2. Description of the Related Art

Dynamic Random Access Memory (DRAM) and the like are widely used as a main memory device of computers. In this case there is a known technique (hereinafter referred to as DMA (Direct Memory Access)) where data are directly exchanged between the DRAM and a peripheral device without involving a central processing unit (CPU) or the like.

In the DMA, the DRAM serving as the main memory device is connected to the peripheral device and the like through a data transfer control device (hereinafter referred to as a DMA controller), and data are directly exchanged between the DRAM and the peripheral device via the DMA controller. In this case the DMA controller receives a request from the peripheral device for acquiring data and based on the received request, the DMA controller issues a command to the DRAM for acquiring the data from the DRAM. Then the DMA controller acquires the data read out from the DRAM based on the issued command, and supplies the acquired data to the peripheral device. In this case, generally, there is a certain amount of delay time (hereinafter referred to as latency) required from when the command is issued to when the data are acquired after the DRAM is accessed by the command Therefore, in a case where a single transfer is being carried out repeatedly in a system, there may arise a problem that the throughput of the system is degraded.

To reduce the latency, a method of a so-called cache function using a cache memory has been used. In this method, when there are data that correspond to an input address and that are stored in the cache memory, the data (cache data) stored in the cache memory are output as output data output from the DMA controller, thereby eliminating the access to the DRAM and enabling improving the throughput of the system.

FIG. 1 is a timing chart schematically illustrating an operation of the DMA controller using the cache function.

First, signals shown in the FIG. 1 are described. In FIG. 1, the data of the address signal denotes a DRAM address. The address Valid signal indicates whether the address of the address signal is valid. The data of the DRAM command signal include information items indicating not only the address but also a burst length, read/write information, and the like. The data of the DRAM data Valid indicate whether the data of the DRAM read data described below are valid. The data of the DRAM read data signal denote the data read out from the DRAM. The data of the cache signal denote the cache data. The data of the output data signal are the data of either the DRAM read data or the cache data selected based on the address, and externally output from the DMA controller. The data of the data Valid signal denote whether the data output from the DMA controller are valid.

Next, the operation of the DRAM controller is described with reference to FIG. 1. As shown in FIG. 1, after acquiring an address A1, the DMA controller issues a DRAM command C1. Based on the issued DRAM command C1, the DRAM controller reads out DRAM read data RD1 and outputs the DRAM read data RD1 to the DMA controller. In this case, there may be a latency of several to several tens of cycles from when the DRAM command is issued to when the read data are acquired (latency of DRAM access) (see FIG. 1).

Next, a case is described where the cache function is used. In this case, after acquiring an address A2, the DMA controller compares the acquired address A2 with an address stored in the cache memory. When it is determined that there are data corresponding to the address A2 in the cache memory (a case of cache hit), the DMA controller selects and outputs data D2 corresponding to the address A2 from the cache memory without issuing the DRAM command. Therefore, in a case of the cache hit, it becomes possible to improve access efficiency without incurring the latency of DRAM access, thereby improving the throughput of the system. As an example, a case is considered where ten of the single transfers are carried out with respect to the corresponding ten addresses and it is assumed that the number of the cache hits is five and the latency of the DRAM access is n cycles. In this case when the system has no cache function, 10 n cycles are required. However, when the system has the cache function, the process can be completed in 5n+5 cycles.

When the cache function is used as described above, the throughput of the system may be improved. As an example, Japanese Patent Application Publication No. H6-161891 describes a computer system capable of performing an effective DMA operation using the cache function and a cache controlling method using cache controlling means.

However, in the DMA controller using the conventional cache function as described above, it is determined whether there are data corresponding to the input address in the cache memory, and based on this determined result, the process of outputting data is carried out serially. Because of the serial operation, when no cache hit occurs, a wait time is generated (required) from when the DRAM command is issued to when the data are output. As a result, an improvement rate of the throughput of the system may remain low (i.e., the throughput of the system may not be greatly improved).

### SUMMARY OF THE INVENTION

According to an aspect of the present invention, there is provided a data transfer control device capable of further improving throughput of the system having the data transfer control device.

Further, according to an aspect of the present invention, there is provided a data transfer control device including a main memory unit; a cache memory unit; a command generation unit configured to generate a command to read out data from the main memory unit in accordance with a first address input to the command generation unit; and a storage unit configured to store an information item indicating whether the first address and data corresponding to the first address are stored in the cache memory unit. In the data transfer control device, when the information item stored in the storage unit indicates that there are no data corresponding to the first address in the cache memory unit, the command generation unit generates the command based on the first address before output of data corresponding to a second address that is input immediately before the first address is input.

### BRIEF DESCRIPTION OF THE DRAWINGS

Other objects, features, and advantages of the present invention will become more apparent from the following description when read in conjunction with the accompanying drawings, in which:

FIG. 1 is a timing chart schematically showing an operation of a conventional DMA controller having a cache function;

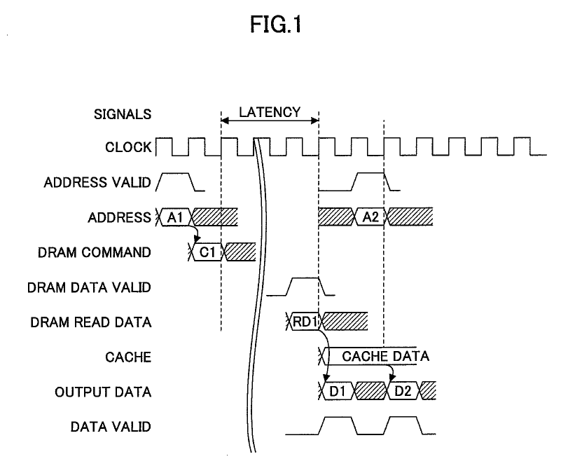

FIG. 2 is a drawing showing a configuration of a DMA controller 100 according to a first embodiment of the present invention;

FIG. 3A is a timing chart schematically showing an operation of the DMA controller 100 according to the first embodiment of the present invention;

FIG. 3B is a drawing showing an operation of a cache information storage circuit 130;

FIGS. 4A through 4C show overhead based on variations of latency;

FIG. 5 is a drawing showing a configuration of a DMA controller 100A according to a second embodiment of the present invention;

FIG. 6 is a timing chart schematically showing an operation of the DMA controller 100A according to the second embodiment of the present invention; and

FIG. 7 is a drawing showing a configuration of a DMA controller 100B according to a third embodiment of the present invention.

### DETAILED DESCRIPTION OF THE PREFERRED EMBODIMENTS

According to an embodiment of the present invention, there is provided a DMA controller capable of improving throughput of the system having the DMA controller when it is determined that there are no data that correspond to a current input address in a cache memory. In this case the DMA controller according to the embodiment of the present invention generates a command for reading data corresponding to the current input address without waiting for an output of data corresponding to an immediately previous input address which is just before the current input address so as to further improve the throughput of the system.

### First Embodiment

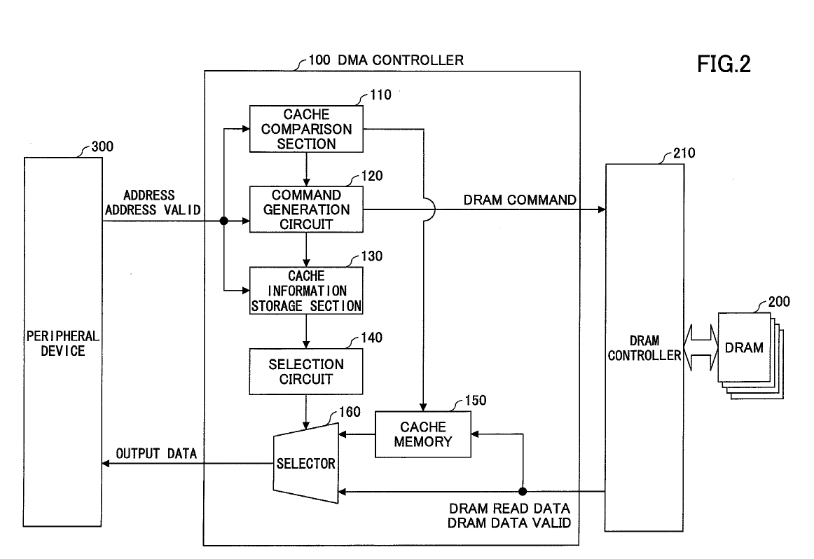

In the following, a first embodiment of the present invention is described with reference to the accompanying drawings. FIG. 2 schematically shows an exemplary configuration of a DMA controller 100 according to the first embodiment of the present invention.

As shown in FIG. 2, the DMA controller 100 is connected to a DRAM 200 via a DRAM controller 210. Further, the DMA controller 100 is connected to a peripheral device 300. In a computer system having the DRAM 200 as a main memory device, the DMA controller 100 is configured to control so as to achieve data communications between the DRAM 200 and the peripheral device 300 without involving a central processing unit (not shown)(hereinafter simplified as a CPU).

When the DMA controller 100 according to this embodiment of the present invention inputs (receives) an address from the peripheral device 300, the DMA controller 100 reads data corresponding to the input address from the DRAM 200 and outputs the read data to the peripheral device 300.

In the following, a configuration and an operation of the DMA controller 100 are described in more detail.

As shown in FIG. 2, the DMA controller 100 includes a cache comparison section 110, a command generation circuit 120, a cache information storage circuit 130, a selection circuit 140, a cache memory 150, and a selector 160.

The cache comparison section 110 compares an address input from the peripheral device 300 (hereinafter referred to as input address) with an address in the cache information storage circuit 130 described below. Further, the cache comparison section 110 determines whether there are data corresponding to the input address in the cache memory 150 (a case of cash hit).

The command generation circuit 120 determines whether a DRAM command described below is to be generated. Upon determining that the DRAM command is to be generated, the command generation circuit 120 generates the DRAM command based on the input address and issues the generated DRAM command to the DRAM controller 210. The DRAM command in this embodiment of the present invention is used to read out data from the DRAM 200 and includes the DRAM address to be accessed, a burst length (the number of words to be serially read in response to a single address designation), read/write selection information, and the like.

The cache information storage circuit 130 stores the input address output from the peripheral device 300 and an information item (a cache hit flag) indicating whether there are data corresponding to the input address in the cache memory 150 (e.g. whether it is a case of the cache hit). More specifically, the cache information storage circuit 130 may be constituted by a FIFO (First In, First Out) circuit for storing the input address and cache hit flag data corresponding to the input address.

The selection circuit 140 selects data to be output (output data) to the peripheral device 300. Specifically, when the cache hit flag of the cache information storage circuit 130 is set, the cache hit flag indicating the case of the cache hit, the selection circuit 140 selects the input address and the data corresponding to the input address stored in the cache memory 150 as the output data to be output from the DMA controller 100. Further, when the cache hit flag of the cache information storage circuit 130 is not set, i.e., the cache hit flag indicating the case of no cache hit, the selection circuit 140 selects the data read out from the DRAM 200 via the DRAM controller 210 as the output data to be output from the DMA controller 100.

The cache memory 150 is configured to temporarily store data once read out from the DRAM 200 by the DRAM controller 210. The selector 160 selects and outputs the output data based on a signal output from the selection circuit 140. More specifically, for example, when it is assumed that a high-level signal indicates the status that the data stored in the cache memory 150 are to be selected, and when the high-level signal is output from the selection circuit 140, the selector 160 may select the data from the cache memory 150 as the output data to be output from the DMA controller 100. On the other hand, upon inputting a low-level signal from the selection circuit 140, the selector 160 may select the data read out from the DRAM 200 via the DRAM controller 210 as the output data to be output from the DMA controller 100.

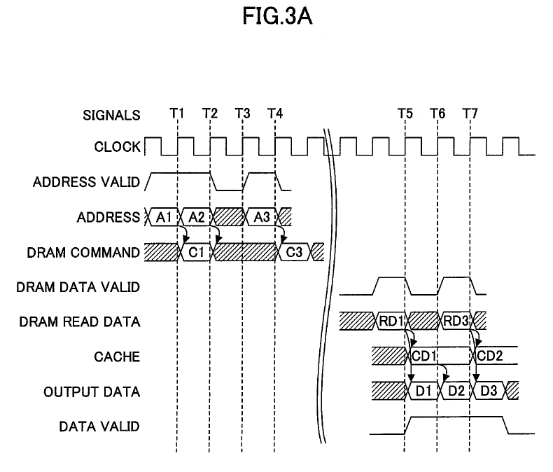

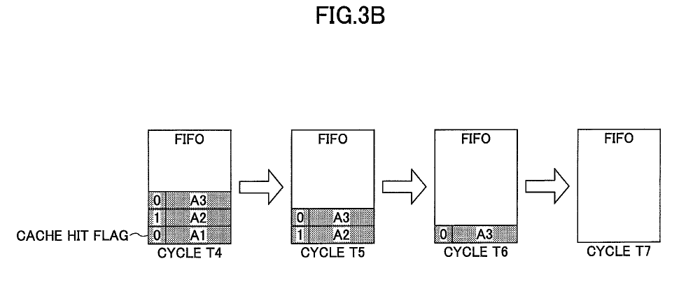

In the following, the operation of the DMA controller 100 according to this embodiment of the present invention is described with reference to the FIGS. 3A and 3B. FIG. 3A is a timing chart schematically showing an operation of the DMA controller 100. On the other hand, FIG. 3B schematically shows an operation of the cache information storage circuit 130.

In the DMA controller 100 according to this embodiment of the present invention, when the data corresponding to current input address are not a cache hit (namely, when it is indicated the status that the data corresponding to current input address are not stored in the cache memory 150), the command generation circuit 120 generates a command without waiting for reading out the data corresponding to the previous input address which is immediately before the current input address.

First, signals shown in FIG. 3A are described. The clock signal shown in FIG. 3A is an operation clock signal commonly provided to the DMA controller 100, the DRAM controller 210, and the peripheral device 300. The address Valid signal indicates whether the input address input from the peripheral device 300 to the DMA controller 100 is valid. In this embodiment, it is assumed that when the level of this address Valid signal is high, the input address is valid.

The data of the address signal denote the input address input from the peripheral device 300 and are used when the command generation circuit 120 generates a command. The data of the DRAM command signal denote a command generated in the command generation circuit 120 and the generated command is supplied to the DRAM controller 210. The data of the DRAM data Valid signal indicate whether the data read out from the DRAM 200 via the DRAM controller 210 are valid. In this embodiment, it is assumed that when the level of this DRAM data Valid signal is high, the input address is valid.

In FIG. 3A, the data of the DRAM read data signal shown denote the data read out from the DRAM 200 by the DRAM controller 210. The data of the DRAM read data signal are input to the DMA controller 100. The data of the cache signal denote the data read out from the cache memory 150 (hereinafter referred to as cache data). In the DMA controller 100 according to this embodiment, it is assumed that once the data (DRAM read data) are acquired from the DRAM controller 210, the acquired DRAM read data are stored in the cache memory 150.

The data of the output data signal denote data (output data) output from the selector 160 in the DMA controller 100, namely the data output from the DMA controller 100 to the peripheral device 300. The data of the data Valid signal indicate whether the output data are valid. In this embodiment, it is assumed that when the level of this data Valid signal is high, the output data are valid.

Next, the operation of the DMA controller 100 is described in more detail with reference to FIG. 3A.

As shown in FIG. 3A, in cycle T1, the DMA controller 100 receives input address A1. Next, in the next cycle T2, the command generation circuit 120 generates a DRAM command C1 based on the input address A1 and issues the generated DRAM command to the DRAM controller 210. In the same cycle T2, the DMA controller 100 may receive the next input address A2. In cycle T2, the cache comparison section 110 compares the input address A2 with address in the cache information storage circuit 130 to determine whether it is a case of the cache hit. When it is determined that there are data that correspond to the input address A2 in the cache information storage circuit 130, (e.g., a case of the cache hit), the command generation circuit 120 does not generate the DRAM command.

In the cache information storage circuit 130 according to this embodiment, as shown in FIG. 3B, the input address and the cache hit flag data are sequentially stored in the order of the receipt of the data (in the order of T1, T2, and T4 in the case of FIG. 3A).

In the following, a configuration and an operation of the cache information storage circuit 130 are described with reference to FIG. 3B.

As shown in FIG. 3B, the cache information storage circuit 130 according to this embodiment is constituted by a FIFO (First In, First Out) circuit having buffer depth corresponding to the number of DRAM commands that can be issued without waiting for output of data corresponding to a previous input address which is immediately before the current input address (hereinafter referred to as previously issuable DRAM commands). In other words, the FIFO circuit constituting the cache information storage circuit 130 has the same buffer depth so that the FIFO circuit can store the data corresponding to the same number of DRAM commands that can be issued from when the command generation circuit 120 issues a DRAM command to when the data corresponding to the issued command is read out from the DRAM 200.

For example, in cycle T4, the DMA controller 100 has already received input addresses A1, A2, and A3 (three addresses) as shown in FIG. 3A. Therefore, the input addresses and the corresponding cache hit flag data are being stored in the cache information storage circuit 130 as shown in FIG. 3B.

As shown in FIG. 3A, in cycle T5, the DMA controller 100 acquires the DRAM read data RD1 corresponding to the input address A1 after the latency of several to several tens of cycles. Then, the DMA controller 100 updates the data of the cache memory 150 and outputs output data D1 to the peripheral device 300.

Further, in cycle T5, in the DMA controller 100, the cache comparison section 110 determines that the cache data CD1 corresponding to the input address A2 are stored in the cache memory 150 based on the data stored in the cache information storage circuit 130. More specifically, the cache comparison section 110 refers to the cache flag data that are stored in the cache information storage circuit 130 and that correspond to the input address A2 to determine whether the cache flag is set. When it is determined that the cache flag is set, it is accordingly determined that it is a case of the cache hit. Upon being determined that it is a case of the cache hit, in cycle T6, the DMA controller 100 outputs the output data D2 corresponding to the input address A2 from the cache memory 150 to the peripheral device 300.

Next, in the DMA controller 100, the cache comparison section 110 determines whether the data corresponding to the input address A3 are stored in the cache memory 150. Namely, the cache comparison section 110 refers to the cache hit flag data that are stored in the cache information storage circuit 130 and that correspond to the input address A3. In the example of FIG. 3B, the cache hit flag corresponding to the input address A3 is not set. Therefore, the cache comparison section 110 determines that it is not the case of the cache hit.

Based on this determination, in cycle T4, the command generation circuit 120 generates a DRAM command C3 based on the input address A3 and issues the generated command to the DRAM controller 210. Upon receiving the DRAM command C3, the DRAM controller 210 reads out DRAM read data RD3 from the DRAM 200 and outputs the read out DRAM read data RD3 to the DMA controller 100. Upon acquiring the DRAM read data RD3, the DMA controller 100 outputs the output data D3 corresponding to the acquired DRAM read data RD3 to the peripheral device 300.

As described above, in the DMA controller 100, before outputting the output data corresponding to first input address input from the peripheral device 300, a command is generated for outputting the output data corresponding to second input address input after the input of the first input address. According to this embodiment of the present invention, by having the configuration described above, the process of generating a command and the process of reading out the output data are independently performed like a pipeline process, thereby enabling improving the throughput of the system having the DMA controller 100.

Next, a case is described where overhead of the variation of the latency is considered.

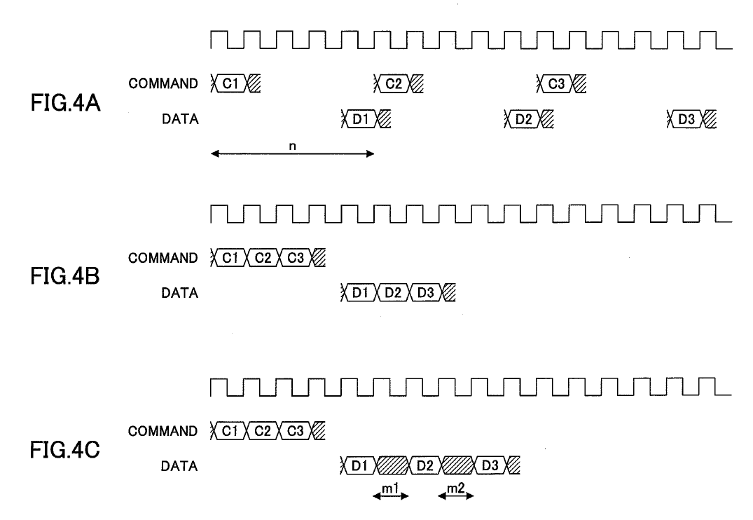

First, the overhead of the variation of the latency in this embodiment of the present invention is described. FIGS. 4A through 4C collectively and schematically shows the overhead of the variation of the latency.

FIG. 4A shows a case where after the command generation circuit 120 issues a first DRAM command, the command generation circuit 120 does not issue any subsequent DRAM command until the output data corresponding to the first DRAM command are read out (a case where no previously issuable DRAM command is issued). FIG. 4B shows a case where after the command generation circuit 120 issues a first DRAM command, the command generation circuit 120 issues a subsequent DRAM command without waiting for the reading out of the output data (a case where a previously issuable DRAM command is issued). FIG. 4C shows another case where the previously issuable DRAM command is issued.

In the case where after a first command is issued, the command generation circuit 120 issues a subsequent DRAM command without waiting for the reading out of the output data, it may be desirable that the output data can be consecutively read out as shown in FIG. 4B. However, in practical use, as shown in FIG. 4C, when the DRAM commands are consecutively issued, there may be delays of several cycles (m1, m2) before the output data are read out. In this embodiment of the present invention, the delays occurring when the output data are read out are defined as the overhead of the variation of the latency.

In this embodiment of the present invention, the number of commands to be issued, the latency from when a command is issued to when the output data corresponding to the issued command are read out, and the overhead of the variation of the latency are designated by symbols “i”, “n”, and “mj” (0≦m<n, j=0,1, . . . , i), respectively. When the previously issuable DRAM command is issued, necessary cycles are given by the formula: (n+(m1+m2+ . . . +mj)+(n−1)). Therefore, even when the overhead of the variation of the latency is considered, the throughput of the system having the DMA controller 100 may be improved.

### Second Embodiment

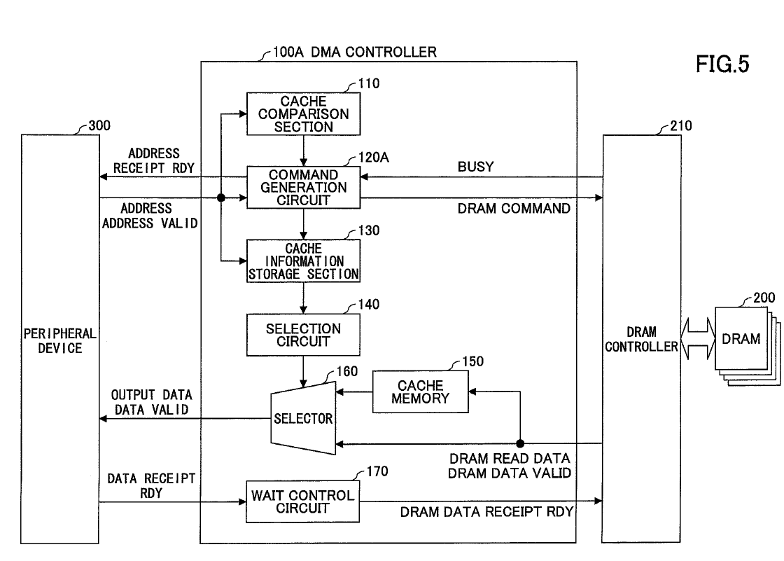

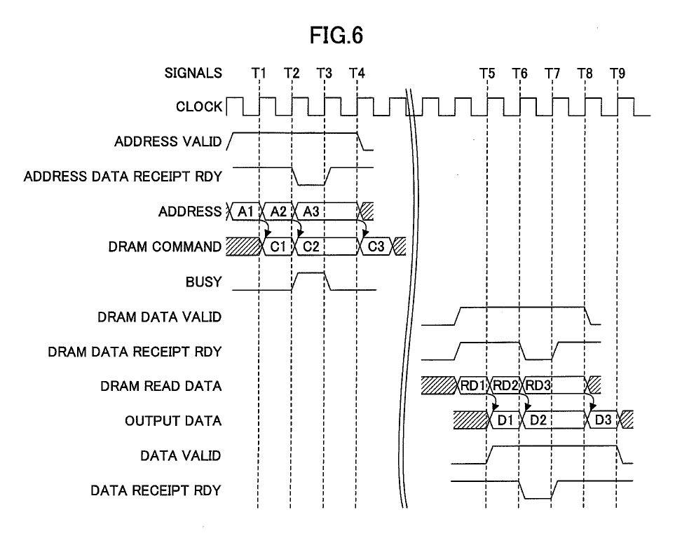

In the following, a second embodiment of the present invention is described with reference to FIGS. 5 and 6. This second embodiment of the present invention is different from the first embodiment of the present invention in that both the receipt of the input address and the output of the output data are controlled. Therefore, in the following description of the second embodiment, only points different from those in the first embodiment are described. Further, the same reference numerals are commonly used in the figures to denote the same elements as in the first embodiment of the present invention and the repeated descriptions thereof are omitted.

FIG. 4 shows a configuration of the DMA controller 100A according to the second embodiment of the present invention.

Compared with the DMA controller 100 according to the first embodiment of the present invention, the DMA controller 100A further includes a wait control circuit 170. The wait control circuit 170 receives a data receipt RDY signal from the peripheral device 300, generates the DRAM data receipt RDY signal and outputs the generated DRAM data receipt RDY signal to the DRAM controller 210. The data receipt RDY signal indicates whether the peripheral device 300 is ready to receive the output data. On the other hand, the DRAM data receipt RDY signal output from the wait control circuit 170 indicates whether the DMA controller 100A is ready to receive the DRAM data read out from the DRAM 200. Therefore, when an external device (such as the peripheral device 300) of the DMA controller 100A becomes ready to receive the output data, the wait control circuit 170 can notify the DRAM controller 210 of the status that the DMA controller 100A can receive the DRAM data read out from the DRAM 200.

Further, a command generation circuit 120A according to this embodiment of the present invention may control the receipt of the input address input from the peripheral device 300. More specifically, for example, the command generation circuit 120A is configured to generate an address receipt RDY signal based on a BUSY signal input from the DRAM controller 210 and output the generated address receipt RDY signal to the peripheral device 300. The BUSY signal is output from the DRAM controller 210 and indicates whether the DRAM controller 210 is ready to receive the DRAM command. When the BUSY signal is being output from the DRAM controller 210, the DMA controller 100A according to this embodiment of the present invention does not output the DRAM command to the DRAM controller 210. The address receipt RDY signal indicates whether the DMA controller 100A is ready to receive the input address.

When the BUSY signal is not output from the DRAM controller 210, the command generation circuit 120A according to this embodiment of the present invention outputs the address receipt RDY signal to the peripheral device 300 to receive the input address from the peripheral device 300. On the other hand, when the BUSY signal is being output from the DRAM controller 210, the command generation circuit 120A does not output the address receipt RDY signal to the peripheral device 300 to temporarily stop receiving the input address from the peripheral device 300.

In the following, the operation of the DMA controller 100A according to the second embodiment of the present invention is described with reference to FIG. 6. FIG. 6 is a time chart schematically showing the operation of the DMA controller 100A according to the second embodiment of the present invention.

As shown in FIG. 6, in cycle T3, the BUSY signal is asserted. Therefore, the command generation circuit 120A generates and outputs the address receipt RDY signal. When the address receipt RDY signal is negated in cycle T3, a period of receiving the input address A3 is extended to cycle T4 in the command generation circuit 120A.

Further, in cycle T3, the BUSY signal is asserted. Therefore, a period of outputting a DRAM command C2 is extended to cycle T4, the DRAM command C2 being generated based on the input address A2 which are input before the input address A3 are input. As shown in FIG. 6, in cycle T4, the address receipt RDY signal is asserted and the BUSY signal is negated. Therefore, in cycle T4, the command generation circuit 120A receives the input address A3 and generates a DRAM command C3 corresponding to the input address A3. In the subsequent cycle (i.e. cycle T5), the command generation circuit 120A outputs the DRAM command C3.

Further, as shown in FIG. 6, in cycle T7, both the DRAM data receipt RDY signal and the data receipt RDY signal are negated. Therefore, a period of acquiring the DRAM read data RD3 by the DMA controller 100A is extended to cycle T8. In the same manner, a period of outputting the output data D2 from the DMA controller 100A is also extended to cycle T8.

As describe above, in the DMA controller 100A according to this embodiment of the present invention, the receipt of the input address and the output of the output data may be temporarily stopped. Accordingly, in the DMA controller 100A according to this embodiment of the present invention, it becomes possible to temporarily stop the data transfer in response to the status of the DRAM controller 210 connected to the DMA controller 100A, the status of the peripheral device 300, and the like. As a result, it may become possible to enhance the versatility of the DMA controller 100A.

### Third Embodiment

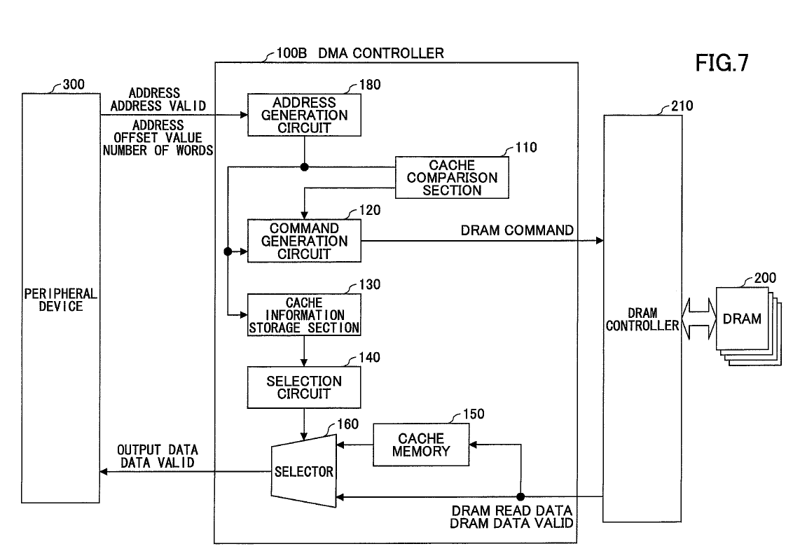

In the following, a third embodiment of the present invention is described with reference to FIG. 7. A configuration of the third embodiment of the present invention is different from that of the first embodiment of the present invention in that there is additionally provided an address generation circuit 180 configured to generate input addresses to be input to the command generation circuit 120 as shown in FIG. 7. Therefore, in the following, only parts different from the first embodiment are described. Further, in the figures, the same reference numerals are commonly used to denote the same or equivalent elements described in the first embodiment and the repeated descriptions thereof are omitted.

FIG. 7 schematically shows a DMA controller 100B according to the third embodiment of the present invention. As shown in FIG. 7, the DMA controller 100B includes the address generation circuit 180 in addition to the elements provided in the DMA controller 100 according to the first embodiment of the present invention.

In the DMA controller 100B, by having the address generation circuit 180, when the input addresses to be used have a regular pattern, a series of input addresses may be generated in accordance with the regular pattern by the address generation circuit 180.

To that end, for example, a predetermined address offset value and the number of words are input from the peripheral device 300 to the address generation circuit 180. In accordance with the input address offset value and the number of words, the address generation circuit 180 may generate a series of input addresses.

More specifically, the address generation circuit 180 acquires one input address as the initial value from the peripheral device 300 and adds the address offset value indicating an address additional value to the acquired initial value. By repeating this additional process with the address offset value corresponding to the number of words, the input addresses to be used may be generated in the DMA controller 100B.

This address generation circuit 180 may also be applied to the DMA controller 100A according to the second embodiment of the present invention.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teachings herein set forth.

The present application is based on and claims the benefit of priority of Japanese Patent Application No. 2008-061758, filed on Mar. 11, 2008, the entire contents of which are hereby incorporated herein by reference.

What is claimed is:

1. A data transfer control device comprising:
a main memory unit;
a cache memory unit;
a command generation unit configured to generate a command to read out data from the main memory unit in accordance with a first address input thereto; and
a storage unit configured to store an information item indicating whether the first address and data corresponding to the first address are stored in the cache memory unit, wherein
when the information item stored in the storage unit indicates that there are no data corresponding to the first address in the cache memory unit, the command generation unit generates the command based on the first address before output of data corresponding to a second address that is input immediately before the first address is input.

2. The data transfer control device according to claim 1, further comprising:
a selection unit configured to select either data stored in the cache memory unit as output data when the information item stored in the storage unit indicates that there are data corresponding to the first address in the cache memory unit or data read out from the main memory unit as the output data when the information item stored in the storage unit indicates that there are no data corresponding to the first address in the cache memory unit.

3. The data transfer control device according to claim 1, further comprising:
a first receiving unit configured to receive a first signal indicating whether the main memory unit is ready to receive the command; and
a first signal generation unit configured to generate a second signal indicating whether the first address can be received based on the first signal received by the first receiving unit.

4. The data transfer control device according to claim 1, further comprising:
a second receiving unit configured to receive a third signal indicating whether the data corresponding to the first address can be output; and
a second signal generation unit configured to generate a fourth signal indicating whether data read out from the main memory unit can be received based on the third signal received by the second receiving unit.

5. The data transfer control device according to claim 1, further comprising:
an address generating unit configured to generate an address to be input to the command generation unit by adding a predetermined address additional value to an input initial value input thereto.

6. A method of controlling data transfer comprising the steps of:
an address input step of inputting an address;
a storage determination step of determining whether a first address input in the address input step and data corresponding to the first address are stored in a cache memory unit; and
a command generation step of, when it is determined that the first address and the data corresponding to the first address are not stored in the cache memory unit, generating a command to read out data from the main memory unit in accordance with the first address before output of data corresponding to a second address that is input immediately before the first address is input.
